(19) United States
(12) Patent Application Publication
(10) Pub. No.: US 2023/0186333 A1
(43) Pub. Date: Jun. 15, 2023

(54) SURVEY SYSTEM WITH CURATION INTERFACE AND DYNAMIC QUESTIONING

(71) Applicant: Possip, Inc., Nashville, TN (US)

(72) Inventors: Shani Dowell, Nashville, TN (US); Adam Thede, Goodlettsville, TN (US); Christine Fisher, Cincinnati, OH (US); Amanda Richards, Dallas, TX (US); Caitlin Churchill, Nashville, TN (US)

(21) Appl. No.: 18/078,755

(22) Filed: Dec. 9, 2022

Related U.S. Application Data
(60) Provisional application No. 63/288,281, filed on Dec. 10, 2021.

(51) Int. Cl. G06Q 30/0203; G06Q 50/20; G06Q 50/00

(52) U.S. Cl. CPC G06Q 30/0203; G06Q 50/20; G06Q 50/01

(57) ABSTRACT

A survey system is configured to conduct multi-step surveys for a pool of respondents while accommodating simple survey interfaces and communication channels such as SMS, email, or other electronic text messaging. Conversation threads with respondents are maintained by establishing a respondent profile for each respondent, which respondent profile may be uniquely identified by a combination of the outbound and inbound communication methods used with that respondent (e.g., such as a respondent with students at two different schools being able to participate in multiple surveys while using the same contact number). Received response may be automatically curated to determine certain attributes (e.g., response category, type, sentiment, etc.), manually curated, or both, and a specialized curation interface is organized to allow for efficient manual curation to confirm or modify automated curation.

### PRIORITY

This applications claims the priority of U.S. Provisional Patent Application 63/288,281, filed Dec. 10, 2021, and titled “System and Method for Gathering, Analyzing, and Reporting Parent Feedback to Schools,” the entire disclosure of which is incorporated herein by reference.

### FIELD

The disclosed technology pertains to a system and method for collecting and curating survey responses.

### BACKGROUND

In schools, as in many other organizations and institutions, there are long-standing barriers in the way of families, students, and staff sharing their voices. It is widely accepted that feedback that is specific, measurable, accurate, achievable, relevant, and timely is very helpful for illuminating and tackling issues. However, there is currently no systematic method or technology that requests and analyzes parent feedback to schools. Communication from parents to teachers has generally been limited to fast and infrequent conferences—generally only 15 minutes long, once or twice a year.

There are many barriers to students, staff members, and families sharing their praise, concerns, ideas, suggestions, etc. Logistical barriers like a system or platform to do so, time, language, and knowing who to contact. Cultural and organizational barriers like trust, fear, and power dynamics. In addition, decision makers and leaders realize feedback is valuable, but are unsure how to hear from diverse and dispersed voices—in a digestible way.

There is a need to hear from students, families and staff. There is a desire to reach the highest number of families possible. There is a need to make providing feedback possible for families with cultural or language barriers. There is a desire to make it quick and easy for people to share their needs, ideas, and feedback before they get too big/difficult to address. There is a desire to enable turn-key solutions for schools to hear from parents with relevant questions & language. There is a desire to enable human-augmented technology. There is a need to analyze data in an actionable way. There is a desire to raise specific issues as well as identify trends. There is a need to enable teachers, schools, and districts to understand and swiftly act upon target audience feedback.

### BRIEF DESCRIPTION OF THE DRAWINGS

The drawings and detailed description that follow are intended to be merely illustrative and are not intended to limit the scope of the invention as contemplated by the inventors.

FIG. 1 shows a schematic diagram of an exemplary computing system configured to collect and manage survey responses.

FIG. 2 is a flowchart of an exemplary set of high-level steps that a system could perform to conduct surveys and curate responses.

FIG. 3A is a flowchart of an exemplary set of steps that could be performed with a system to build and manage communications with respondent profiles.

FIG. 3B is a schematic diagram of exemplary data structures used when building respondent profiles.

FIG. 4 is a flowchart of an exemplary set of steps that could be performed with a system to conduct a survey.

FIG. 5 is a flowchart of an exemplary set of steps that could be performed with a system to provide automated curation, manual curation, or both.

FIG. 6A is a screenshot of an exemplary respondent status interface that displays respondent status information.

FIG. 6B is a screenshot of an exemplary curation interface usable to review and update curation of responses.

FIG. 6C is a screenshot of an exemplary feedback interface that displays feedback status information.

FIG. 6D is a screenshot of an exemplary feedback action interface that displays feedback action information.

FIG. 6E is a screenshot of an exemplary sentiment interface that displays sentiment status information.

### DETAILED DESCRIPTION

The inventors have conceived of novel technology that, for the purpose of illustration, is disclosed herein as applied in the context of survey response collection and management. While the disclosed applications of the inventors' technology satisfy a long-felt but unmet need in the art of survey response collection and management, it should be understood that the inventors' technology is not limited to being implemented in the precise manners set forth herein, but could be implemented in other manners without undue experimentation by those of ordinary skill in the art in light of this disclosure. Accordingly, the examples set forth herein should be understood as being illustrative only, and should not be treated as limiting.

Varying implementations of the disclosed system may be configured to: use artificial intelligence to categorize qualitative comments into ten categories based on key words identified in comment; provide interfaces and tools for manual curation and confirmation of categorization and content; identify themes amongst comments and provide recommendations to the school based on the theme; generate reports; add data to dashboards for display cumulative information across a period of time; and perform other steps and features as disclosed herein. While disclosed examples and descriptions of the system may refer to uses and applications within the context of survey responses in schools and academic settings, it should be understood that implementations of the disclosed technology may be utilized in a variety of contexts beyond schools and academic settings (e.g., such as for gathering workplace culture or satisfaction survey data, customer or client experience survey data, and other types of data from varying contexts).

Some implementations may include a cloud hosted web application, integrated with third-party services, to manage contact data, interactive surveys, and custom crafted reports and dashboards of aggregated and analyzed survey responses. In some implementations, the system may be configured such that the database and the user interface process user contact information from both file system sources as well as application programming interfaces with verified and authenticated third party contact data management services. Contact data may be parsed and distributed into numerous database tables for optimal account association as well as attribute management.

In some implementations, the system is configured such that the database and the user interface to manage the distribution of account specific survey prompts to the account specific contacts stored in the database. Distribution may be managed via email as well as SMS (through verified and authenticated third party application programming interfaces). In some implementations, the system is configured such that the database and the user interface manage an individual contact's survey experience. Interactive survey experiences happen both through the web application in a web browser as well as via an application programming interface for SMS managed interactions. Survey content may be parsed, analyzed, processed for language translation, and stored in the database.

In some implementations, the system is configured such that the database and the user interface manage the creation of account specific custom reports built with the content of that particular account's contacts' survey content. Custom reports are stored in the database and available for distribution via PDF as well as through a web browser. The router interacts with the database for further processing and analysis of all survey content and reporting content for the automatic generation of visualized dashboards and reports.

Implementations of the disclosed system may utilize data imports, on-boarding, and user management features for new customers. When a new customer joins the system, the system automatically syncs with the customer's student information system (“SIS”) through a third party (for example, Global Grid for Learning™ or Clever™), for example. The system may test data for reachability and produces data quality dashboards for customers. Users may receive material from school about the system and survey process. Customized landing pages may be provided to give respondents more information. Admin accounts may be automatically created with a link to SIS or import. Administrator users can add users/update contact information on a one-off basis. Admins can add other admins within their scope, subject to some configured limitations, and can manage their profiles, settings, and passwords. Information imported may include parent name, contact mobile number, contact email, and language, for example.

Some implementations of the system enable turn-key solutions for users to hear from a target user audience (e.g., parents, staff, students) by using relevant questions and language. Some implementations may include status check and custom question features. With a status check feature, admins are able to schedule status checks using the system. Admins are notified of upcoming status checks and pending deadlines. Admins are able to schedule and assign custom questions or other actions to upcoming status checks and schedule them out for one or more future time periods (e.g., school year/regular season, summer season).

In some implementations, the system comprises an artificial intelligence (“AI”) check on quality of custom questions and offers suggestions on improving the question. An admin can select whether a custom question is quantitative or not. The system automatically assigns reporters and reviewers to reports based on the status check schedule. The assigned reporter/reviewer may be adjusted for an individual day/week. The reporter/reviewer may be able to see only their assigned reports in their reporting workflow.

Implementations of the disclosed system may include a feature wherein status checks are sent to gather data and hear from families automatically. Standardized sentiment and follow-up questions that are specific to a target user audience (e.g., parents, staff, students) can be automatically sent by the system based on account type. Different sequences can be sent throughout the year based on user response (prompts for non-responders, frequent responders, etc.). Custom questions may be selected from a bank of template questions (e.g., in April, it may be helpful to ask questions about state testing requirements). Translation of both status check outgoing text as well as user response incoming text may offered in various languages, and reports may include feedback in one language or multiple languages.

In some implementations, the system enables human-augmented technology and actionable analytics of data via reporting. Comments may be automatically bucketed into themes, topics, meanings, or other categories using machine language analysis. User anonymity may be preserved based on articulated preference. Themes may be determined from comments using keyword analysis and other language analysis. Account deactivation/updates may be accomplished with an automatic tool bar and then a summary is automatically generated with account deactivation/language update.

In some implementations, the system allows for follow-ups/recommendations. Comments needing follow-up or recommendations are tagged by reporters with a key word, such as may be selected from drop down list with option to freehand (e.g., after school activities). All comments with same or similar key words are grouped together with contact information. The reporter generates or the system auto-generates recommendations with links to content/a blog on the system's website, which may be provided to respondents and/or reviewers in order to share information and best practices related to the comment topic or theme. The recommendations can be edited by reporter and/or reviewer in parallel or in sequence. Theme tags can be selected to automatically appear on reports to different user types (e.g., school administrators, parents). The system auto-generates reports by using themes from the school report. Statistics are available and visible for reporters and management to see speed and quality of report preparation. Reports can be sent to administrators and multiple custom messages are stored to be able to send with reports. Reports are sent to appropriate audience (e.g., district administrators, curriculum leads, etc.) with notifications customized to scope of role (e.g., in some implementations multiple school access would only receive one notification).

In some implementations, the system enables users to understand and swiftly act upon target audience feedback collected via status check surveys. Users are able to manage and analyze data by using reports, dashboards, account information, and custom data reports. As an example, reports comprise information related to a survey event, and may include sections such as quantitative trends, highlighted responses, account updates, themes with follow-up and recommendations, and qualitative comments by bucket. Qualitative data may be categorized by AI and confirmed by manual curation. Follow-ups can be made directly from a report with a share button or a respond button. “Share” enables an admin to email follow-up to internal team and also enables sharing directly to social media for highlight quotes. “Respond” allows the admin to respond by text or email directly to the user via the system; this can be done keeping user anonymity if needed. The school admin can click on a user's name to get more context on comment. User pop-ups would include frequency of response and user sentiment scores.

As further example, in some implementations dashboards comprise information related to survey events cumulative across the season and previous seasons, and may allow school and district administrators to view response rates and sentiment rates over one or more seasons, with the ability to see benchmarks and track vs. goals. In some implementations, the dashboard may allow a user to drill down by segments of a community (e.g., school level, type, titlel), and may provide a qualitative comments summary (e.g., proportion of comments by category) over the course of the season. The dashboard highlights where trends may be predictive of future sentiment issues. The dashboard may provide a language breakdown of responders. The dashboard may display highlighted comments and sort positive and negative feedback into categories.

As further example, in some implementations account information is employed to understand and swiftly act upon target audience feedback. A data quality dashboard shows a breakdown of contact information quality. This dashboard enables accounts to understand why they are not hearing from their users in order for them to take steps towards better engagement with users who cannot be contacted via mobile phone, email address, or other contact information due to incorrect or unavailable information. Custom data reports may comprise category reports, non-responder reports, unique responder analysis, equity reports, school board reports, and other reports developed from time to time. The system may also comprise a celebration package and/or data package. Complementary products may include a parent app, a store, professional development, professional services, data and insights, and combinations thereof.

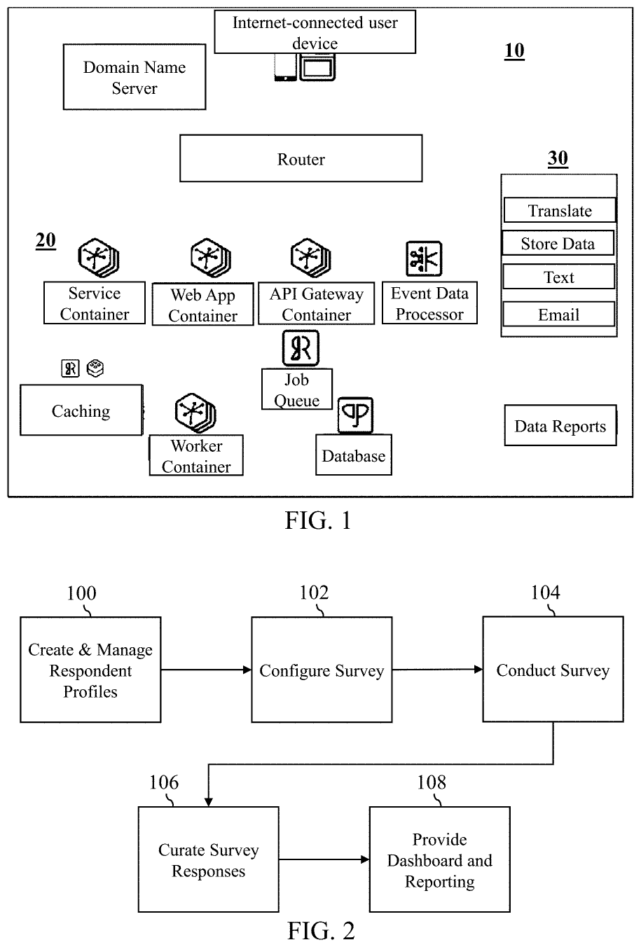

Turning now to the figures, as shown in FIG. 1, in one embodiment, a computing system (10) for gathering, analyzing, and reporting parent feedback to schools comprises: a domain name server, one or more internet-connected user devices/interfaces, a router, one or more containers (20) for storing computer-executable instructions for controlling the computing system (10), an events data processor, a communication component (30) for executing the computer-executable instructions stored in the one or more computer-readable storage mediums (10), a caching with in-memory key-value data store (or add in), worker containers, job queue, database, and data reports. The user device may be a computer, tablet, mobile device, smart TV, etc. comprising a web browser and/or application which is able to communicate with other systems (e.g., web servers or other devices) via the network. The communication component (30) allows translation, data storage, text/SMS, and email. The computer-executable instructions allow the computing system (10) to gather, analyze, and report parent feedback to schools. It should be understood that user devices (e.g., smartphones, personal computers), servers (e.g., physical, virtual, cloud-based), and other computing devices that interact with or are part of the system may include processors, memories, communication devices, user interfaces, and other computer components as may be necessary or useful in sending, receiving, storing, analyzing, and modifying information and data as described herein.

FIG. 2 is a flowchart of an exemplary set of high-level steps that a system could perform to conduct surveys and curate responses. The system may create (100) and manage a plurality of respondent profiles that correspond to survey respondents, which may include associating unique respondent identifiers with each profile, and using profile information to direct outbound messages being sent to respondents, and to receive and contextualize inbound messages received from respondents. The system may allow an administrator to configure (102) various survey settings and configurations. This may include, for example, a survey schedule (e.g., weekly, monthly, quarterly surveys, semi-random surveys, etc.), survey respondent pool (e.g., an entire school population, a single grade population, a single teacher or class population, etc.), question number, content, order, and other question related configurations, and so on.

The system may conduct (104) surveys based on configuration (102), which may include automatically transmitting survey questions to a respondent pool based on a configured schedule or user initiated action, receiving and analyzing responses to determine various response attributes, and dynamically selecting and providing follow-up questions based on determined response attributes. The system may curate (106) survey responses, which may include automatically analyzing and curating survey responses to determine response attributes, or may include providing a manual curation interface to administrators of the system to manually curate survey response and determine response attributes, or both. The system may provide (108) various survey dashboards and reports that allow administrators to view various high level or aggregate analyses and results of surveys, and provide administrators with tools and interfaces to respond to, address, or take action on particular survey responses.

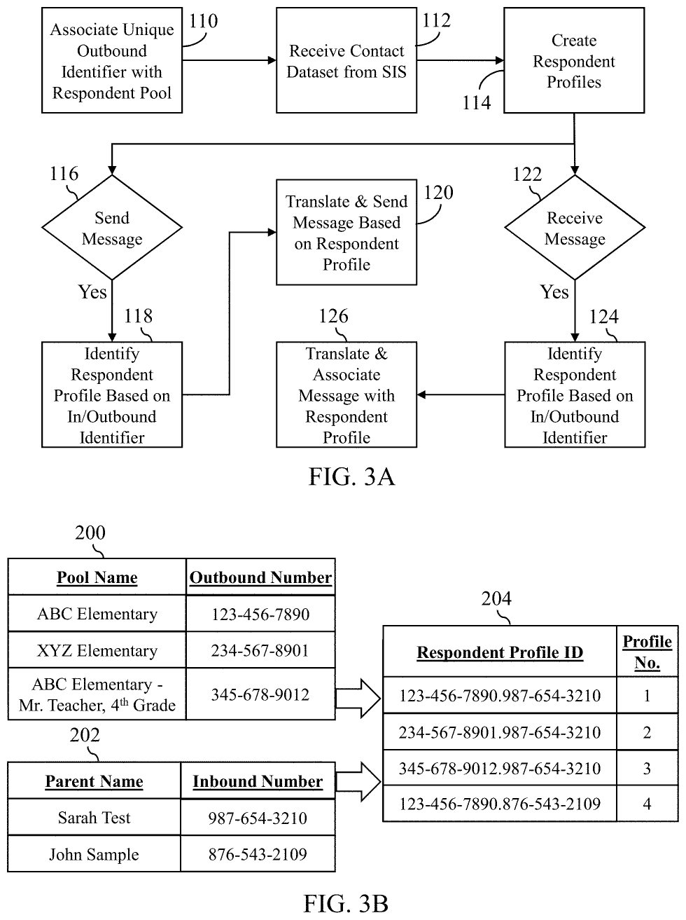

FIG. 3A is a flowchart of an exemplary set of steps that could be performed with a system to build (100) and manage communications with respondent profiles. A significant challenge in managing automated survey processes is ensuring that outbound messages reach the desired recipients, and that inbound messages are properly associated with the recipient from which they originate. Conventional approaches to survey technology may address this challenge by having respondents register or receive a user account or other credentials that are used to log into and access a survey website, portal, or other software application. However, such approaches can create friction and barriers for respondents (e.g., due to resistance to creating another account, security or privacy concerns, lost passwords, etc.), and so will reduce the volume and consistence of responses, and thus the overall quality of responses (e.g., technical barriers may be more likely to prevent responses from technologically unsophisticated respondents, and thoughts and concerns from such segments may be underrepresented in survey responses over time).

Implementations of the disclosed system address this concern by creating a respondent profile for each respondent, and associating a unique, non-arbitrary profile identifier with each profile that is based on the communication channel used to communicate with the profile (e.g., SMS or other text messaging, email, or other messaging service, messaging channel, or messaging interface). As an example with reference to FIG. 3B, that figure shows a schematic diagram of exemplary data structures used when building respondent profiles. A first data structure (200) may be a database or dataset that defines a plurality of respondent pools that may be targeted by a survey (e.g., “ABC Elementary” describes a respondent pool of every student at ABC Elementary, while “ABC Elementary—Mr. Teacher, 4^{th} Grade” describes a respondent pool of every student enrolled in Mr. Teacher's 4^{th} grade class at ABC Elementary), and a unique or semi-unique outbound contact data for each respondent pool from which messages to those respondents will be transmitted by the system (e.g., electronic text survey messages transmitted to the ABC Elementary respondent pool will originate from 123-456-7890).

A second data structure (202) may be a database or dataset that defines a plurality of respondents that may be associated with one or more respondent pools (e.g., Sarah Test may be a parent of one or more students at ABC Elementary, but may also have students at XYZ Elementary, or may have one student enrolled in Mr. Teacher's course and one that is not, and so on), as well as a unique or semi-unique inbound contact data for each respondent (e.g., electronic text survey messages transmitted to Sarah Test will be transmitted to 987-654-3210).

A respondent profile data structure (204) may be a database or dataset that stores various information about a particular respondent, such as past survey responses, preferred language, contact information, and a respondent profile identifier associated with the respondent profile. As shown in FIG. 3B, the respondent profile identifier may be a combination of outbound number (200) and inbound number (202), and the profile dataset (204) contains several entries for Sarah Test (e.g., the first three rows of that table represent, respectively, Sarah Test as a recipient for messages for ABC Elementary, messages for XYZ Elementary, and messages for Mr. Teacher's 4^{th} grade class at ABC Elementary).

In this manner, the respondent profile identifier is advantageously embedded in or otherwise associated with each communication, and so there is not a need for respondents to be assigned unique account or credentials, or a need for respondents to utilize more complex survey websites, portals, or software. For example, where a survey is being sent to the ABC Elementary respondent pool, the outbound message sent to Sarah Test may be associated with respondent profile #1. Where a survey is being sent to the XYZ Elementary respondent pool, the outbound message sent to Sarah Test may be associated with respondent profile #2.

In this manner, the system is able to route outbound messages transmitted to Sarah Test and incoming messages received from Sarah Test to the proper profile and conversation thread based upon the profile ID, and without requiring that any additional identifiers, cookies, tokens, etc., be exchanged as part of the communication in order to identify the proper profile and conversation thread.

As an example, suppose that Sarah Test has students enrolled at both ABC and XYZ Elementary, and has only provided a phone number for contact information, and has requested that all communications be by way of SMS or electronic text message communication with the provided phone number. In this example, SMS messages will need to be sent to Sarah's provided phone number, and responses received from the same, while allowing the system to properly thread outbound and inbound messages into conversation threads that are unique to each combination of respondent pool and respondent, all while working within the constraints of SMS and electronic text messaging (e.g., limited or no ability to attach files, thread identifiers, etc. to SMS and other text messaging exchanges). Otherwise, outbound messages sent to Sarah may be confusing as to whether they relate to ABC or XYZ Elementary, and it will also be difficult or impossible to determine which school or student Sarah's responses relate to.

Returning to the discussion of FIG. 3A, the system may perform profile management as described above by associating (110) unique outbound identifiers with each respondent pool, as illustrated by the first data structure (200). While the examples shown and described relate to phone number based SMS and electronic text messaging, it should be understood that other unique outbound identifiers will also be sufficient and may be used instead (e.g., such as a unique or semi-unique email address, social media handle, automated voice call number, or other identifier that is inherent to a communication channel or interface). The system may then receive a contact dataset from a school's SIS that identifies parents, guardians, or other respondents for each student, and provides contact information for the respondents. In some implementations, the SIS may also include information identifying the respondent pool that each profile should be associated with (e.g., the contact dataset may identify that Sarah Test has a student enrolled at ABC Elementary, and so should be part of that respondent pool, and the same student is enrolled in Mr. Teacher's 4^{th} grade class at ABC Elementary, and so should be part of that respondent pool as well), while in other implementations respondents may be associated with particular pools by a user of the system during configuration (102) of surveys and other settings.

The system may then create (114) the respondent profiles based on the unique outbound identifier and the contact dataset, as illustrated by FIG. 3B, so that subsequent messages may be properly associated with each profile as a conversation or thread. For example, where the system subsequently needs to send (116) a message to a respondent pool, the system may identify (118) the respondent profiles associated with the respondent pool based on the profile identifiers, and may translate and send (120) the message based on the respondent profile so that the message is both received by the intended recipient, and associated with the corresponding conversation thread for that respondent profile. The need for translation prior to sending may be determined based on the respondent profile's language preference or other preference, and outbound messages may be translated from an original language to a target language using a translation function, for example.

Similarly, where the system receives (122) a response message from a respondent profile with which a conversation thread has been started, the system may identify (124) the respondent profile based on the profile identifier, and may translate and associate (126) the response message with the corresponding respondent profile that it becomes part of the correct conversation thread with that profile. As with prior examples, translation may be performed based upon a determination of the language of the inbound message, a language preference associated with the corresponding respondent profile, or other settings or configurations, and translation may be performed using a translation function, for example. As has been described, approaches such as the above advantageously rely upon a hybrid identifier that is present within the communication channel or interface itself, and so need not be exchanged as a cookie, session identifier, or text content embedded arbitrary identifier, as such approaches may be impossible or at least undesirable in the case of SMS or electronic text messaging interfaces and other communication channels that may be preferred by significant portions of respondents.

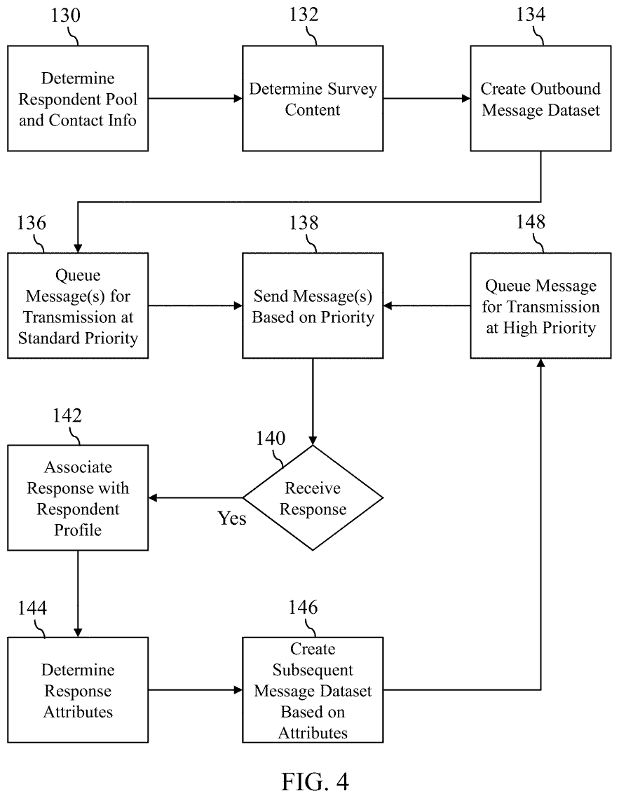

FIG. 4 is a flowchart of an exemplary set of steps that could be performed with a system to conduct (104) a survey. The system may determine (130) a respondent pool and corresponding contact info based on created (100) respondent profiles and configurations (102), and may determine (132) the survey's content based on configurations (102). Survey content may vary by implementation and user, but will generally include short text messages that include a prompt for a quantitative response, qualitative response, or both.

One advantageous approach to configuring survey content and question order is to send a first question prompting for a quantitative response, such as “Is ABC Elementary doing a good job this week? (Reply with 1-Yes, 2-Maybe, 3-No).” As each respondent responds, their response is associated with a quantitative response type (e.g., Yes, Maybe, No), and then a qualitative follow-up question is asked based upon the quantitative response type and/or other factors (e.g., a follow-up question responsive to “Yes” may be to prompt the respondent to provide qualitative praise or additional feedback that describes their answer, while a follow-up question responsive to “No” may be to prompt the respondent to provide qualitative criticism or additional feedback that describes their concern).

The system may also create (134) outbound message datasets for each respondent profile, and outbound message datasets may include information identifying each respondent profile's conversation thread, survey content (132), translations of survey content (e.g., such as described in the context of FIG. 3A), scheduling or timing related information (e.g., such as where a particular respondent is configured to only receive messages after 5pm), and other information used by the system to execute and transmit outbound messages. The system may then queue (136) one or more outbound message dataset for transmission to respondents, which may include providing the outbound message datasets to an SMS or electronic text messaging system or interface, an email system or interface, or another automated messaging or communication system capable of rapidly and reliably transmitting bulk outgoing communications.

In some implementations, such as those that utilize a two-step respondent interaction as described above, a “first” message may be sent to an entire respondent pool in sequence or in parallel to start a new survey conversation with each respondent profile, while a “second” message may be sent to respondents to the “first” message in reaction to their response. In such implementations and in others, the system may be configured to queue (136) outbound message datasets for the “first” message at a standard priority for transmission, while outbound message datasets for the “second” message may be queued for transmission at a higher priority, as will be described in more detail below. This allows for effective prioritization of outbound message transmission where a communication pipeline or other resources are volume limited in some manner (e.g., an automated SMS or text messaging system or interface may be limited to 1,000 outbound transmissions per minute, while district-level school populations and respondent pools may number in the hundreds of thousands).

Queue prioritization for transmission of outbound messages may be implemented in varying ways, and for example may include utilizing separate queues that are reserved for different priority transmissions, may include utilizing a single queue that selects based upon priority instead of strictly upon first-in-first-out or FIFO principles, or a single queue where high priority outbound messages are queued at the front of the queue instead of the end, or other approaches. In this manner, “first” messages that begin the conversation with a respondent may be delayed with minimal downside since the conversation has not yet begun, while higher priority “second” messages that continue the conversation with a respondent may be prioritized to occur with minimal delay and as close to real-time as possible, as respondents are more likely to respond to the “second” message if it arrives immediately or soon after sending their response to the “first” message.

Returning to FIG. 3, after sending (138) messages the system may begin to receive (140) responses from individual respondent profiles, often in parallel with messages still being sent (138) to the remaining portions of a respondent pool. As responses are received (140), the system may associate (142) each response with a respondent profile and conversation thread, as has been described, and may analyze the received (140) response to determine (144) one or more response attributes. Analysis and determination (144) of response attributes may utilize pre-configured rule sets, pre-configured keyword searches, and other preconfigured and/or expert function analysis, or may utilize artificial intelligence, natural language processing, machine learning, or other more complex model based function analysis, or both, as will be described in more detail below.

In some implementations, automatic curation of responses by expert and/or artificial intelligence functions may be supplemented by manual curation, review, and confirmation while the survey is being conducted (104), after completion of the survey, or both, as will be described in more detail below. Some attributes may be advantageously determined while the survey is being conducted (104), and so may be used by the system to create (146) a subsequent message dataset (e.g., a response message dataset, or a “second” message dataset, as described above) based on the attributes, which may be queued (148) for transmission at a higher priority, as has been described. Attributes that may be determined (144) at this stage will vary be implementation, but may include a message category (e.g., academic, teacher and staff, community and culture, operations, general), a message type (e.g., praise, feedback/criticism), sub-types or similar attributes (e.g., a message of type praise may have a sub-type of “high-praise”, a message of type feedback may have a sub-type of “follow up needed”), theme or sub-category (e.g., an academic category may have a sub-category of “student academic struggles”), urgency (e.g., based on category, type, sub-type, etc., the response may have an urgency of high/medium/low, hot/medium/cold, 1-10, etc.), and other attributes.

When creating (146) a subsequent message dataset based on these attributes, the system may determine the content and other characteristics of the subsequent message dataset based on those attributes. For example, where a response attribute is “praise”, the created (146) subsequent message may include a prompt for the respondent to identify a particular teacher or staff person that is the target of praise, or may simply ask for additional description of the praise. As another example, where a response attribute is “feedback”, the created (146) subsequent message may include prompt for the respondent to provide additional description of the concern or criticism. Response attributes may be utilized by the system in other downstream processes that need not occur in parallel with conducting the survey (104), which may include flagging any “feedback” responses for a follow up call by a teacher or administrator at a later time and other actions as will be described in more detail below. Once created (146), the response may be queued (148) for transmission and, where supported by a particular implementation, may be queued (148) for transmission at a higher priority so that the response is received by the respondent as quickly as possible.

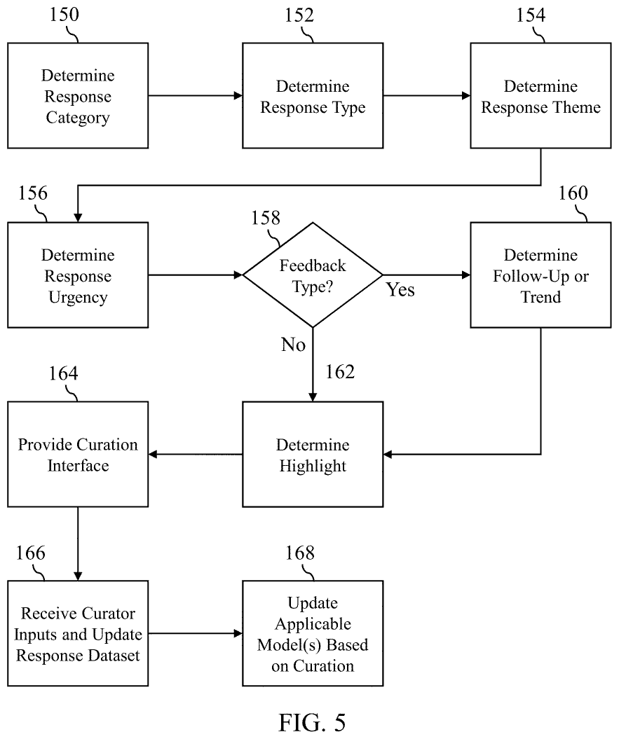

FIG. 5 is a flowchart of an exemplary set of steps that could be performed with a system to provide (106) automated curation, manual curation, or both. Some reference has been made to curation, both in the descriptions of FIG. 4 and elsewhere, and in some implementations may be related and relevant to the steps of FIG. 5 (e.g., steps such as those shown in FIG. 5 may be performed while a survey is conducted to provide “second” message or follow up responses in near-real time, or may be performed after completion of a survey, or both).

While the attributes determined by curation for a particular response will vary by implementation, as has been described, they may include category and sub-category or theme, type and sub-type, urgency, and other attributes, and may be determined based upon automated analysis by expert function, AI function, and other analytic functions, manual curation, or both. As an example, the system may determine (150) a response category based upon a natural language analysis or keyword search analysis of response content. While there is no upper limit on the number of response categories, a small selection of categories has some advantage as will be described in more detail below, and it may also be advantageous to enforce a 1-to-1 relationship between response category and response rather than allowing a response to be associated with multiple categories.

As another example, the system may also determine (152) a response type based upon a natural language analysis or keyword search analysis of response content, or another analysis such as a sentiment analysis. As with category, it may be advantageous to limit the number of types to a small selection (e.g., praise and feedback/criticism), and it may be advantageous to enforce a 1-to-1 relationship between response type and response, even though some responses may arguably include both praise and criticism.

As further example, the system may also similarly determine (154) a response theme or sub-category, and may determine (156) a response urgency. Response theme or sub-category may be determined similarly to category (e.g., natural language processing, keyword search, etc.) and may be selected from a set of preconfigured sub-categories falling under each parent category, while urgency (156) may be determined based upon natural language processing, semantic analysis, or other analysis, and may also be based in part upon other attributes determined for the response (e.g., if a response is a type of feedback/criticism, and the sub-category or theme is “bullying”, the urgency may be determined (156) as higher compared to a sub-category or theme of “lunch choices”).

Determination of subsequent attributes may vary based upon already determined attributes in some implementations. For example, where a response is of a type “praise,” the response may be further analyzed to identify a highlight or portion of the response text that can be isolated and used to summarize or highlight good work by teachers and staff. As another example, where a response is of a type “feedback/criticism,” the response may be further analyzed to identify whether any follow up or direct action by the school is warranted.

As further example, where the system determines that the response type is “feedback” (158) the system may further analyze the response using a different analytic function (e.g., expert function, AI function) that is specialized for identifying or determining (160) a follow-up action that may be needed to address the feedback. As has been described, whether praise or feedback, responses may also be analyzed to determine (162) a highlight-worthy subset of the response content that may be isolated from the overall content and used to summarize the response, used to promote positive outcomes, or used to highlight the need to address a negative situation.

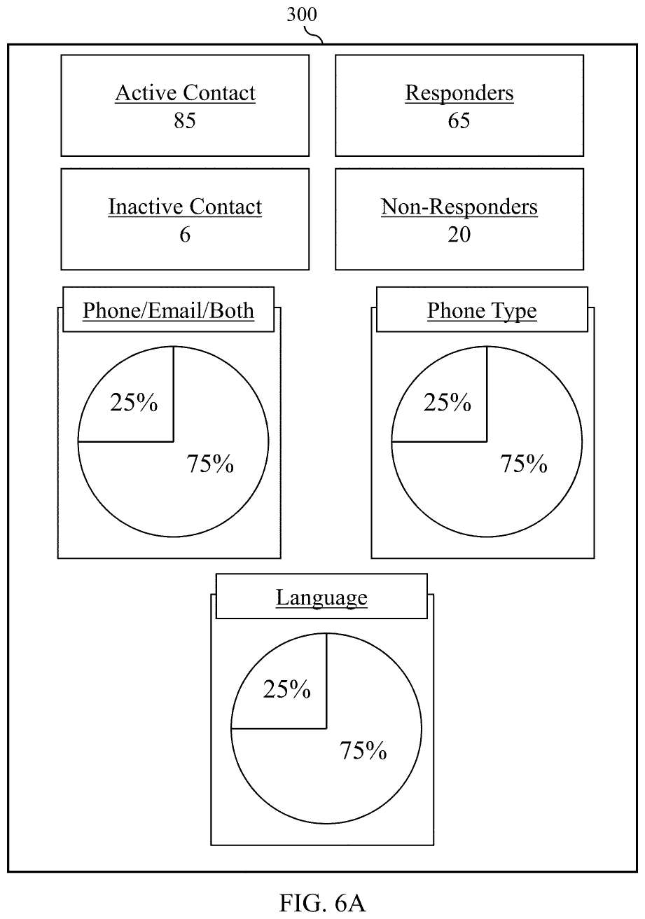

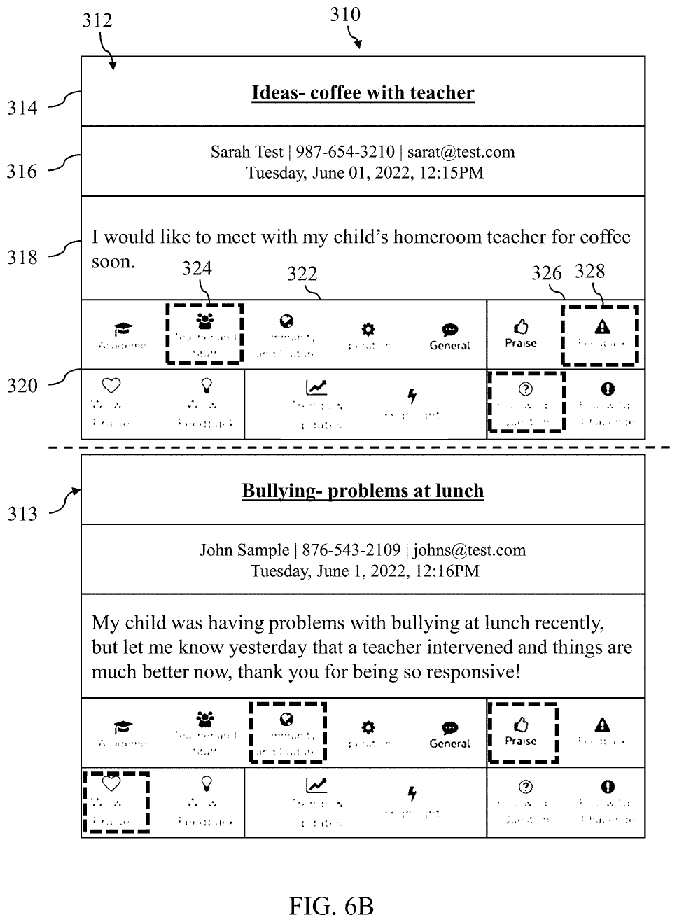

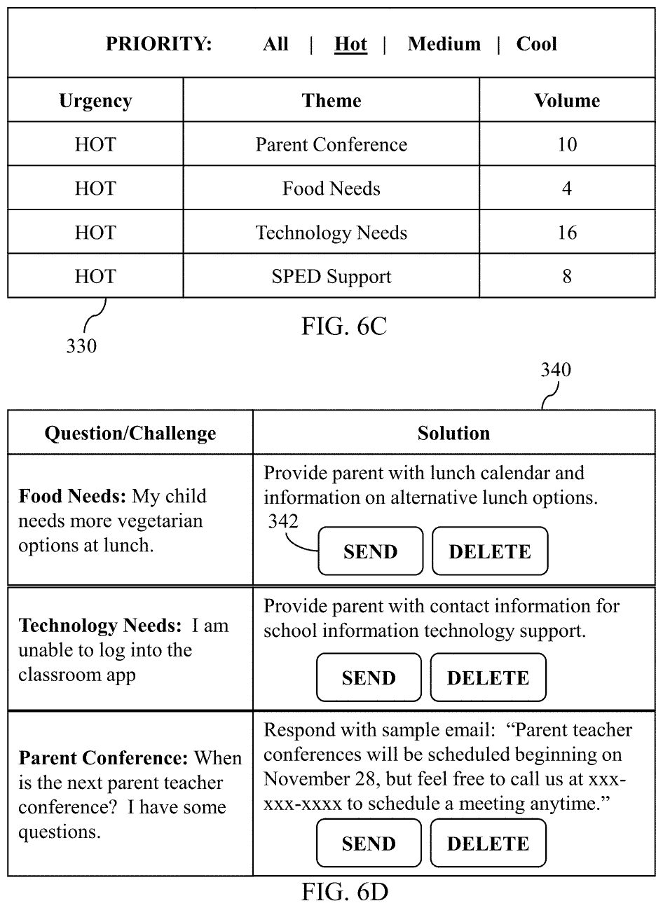

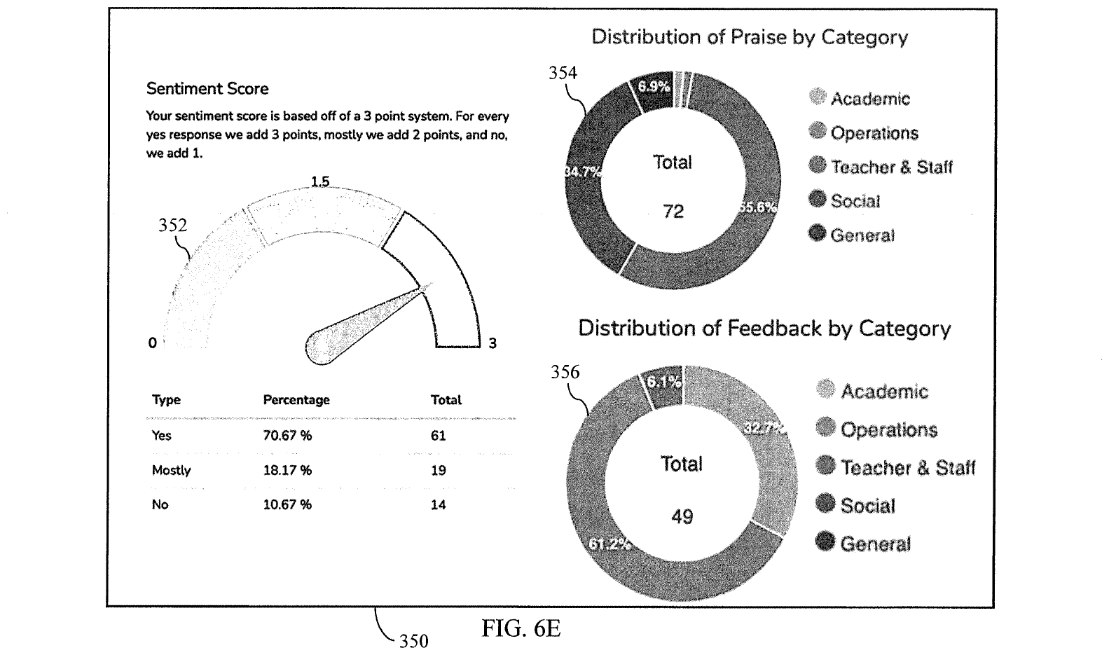

While the above largely describes automated analysis and curation of responses, implementations of the system may also utilize manual curation of responses to review and confirm automated analysis, or to correct and fill in gaps where automated analysis is imperfect. For this purpose, the system may provide (164) a curation interface to curator users, such as the example curation interface (310) shown by FIG. 6B. using such an interface, curator users may review response datasets and automatically determined attributes, and may correct, change, or update any attributes as may be needed. This may include where the system determines (150) and assigns a category attribute to a response that a curator user disagrees with upon later review, or may include where the system is unable to determine and assign an attribute with any level of confidence (e.g., if an automated analysis determines with 50% confidence that the response type is praise, and a 50% confidence that the response type is feedback/criticism, the system may leave the attribute unassigned).

As curator inputs from the curation interface are received (166), the system may update the response dataset for the affected response to update one or more attributes, and may maintain a record of such changes for further review and or action (e.g., such as identifying a need for training or guidance for manual curators, or identifying a need to update or refine expert modules, rule sets, or AI functions used for automatic curation). As one example, each manual change to an automatic attribute assignment may be flagged for further review or consideration. This may include incorporating associated responses and attributes into a training dataset or configuration for the corresponding analytic function that produced the response, so that over time manual curation (166) results may be used to reinforce or correct certain patterns within the training datasets or expert module configurations, so that they are refined and improved over time.

FIGS. 6A through 6E show screenshots of exemplary interfaces that may be displayed to and used by users of the system. FIG. 6A shows an exemplary respondent status interface (300) that displays respondent status information for a particular respondent pool (e.g., a district population, school population, class population, etc.). Active contacts identify the total number of users in respondent pool, while inactive contacts shows the number of users for which the system has contact information, but have opted out or otherwise been removed from a respondent pool. The responders and non-responders section shows the total number of active contacts that have responded to a survey question (e.g., at least one response all time, at least one response within last six months, response to most recently sent survey question, etc.), and the total number of active contacts that are deemed non-responsive. The interface (300) may also include graphs, charts, or other summaries or visualizations indicating information about respondents, such as number or proportion of respondents using phone, email, or both for contact information, whether respondent phones are smartphones are landlines, what language is spoken by respondents, and so on.

FIG. 6B is a screenshot of an exemplary curation interface (310) usable to review and update curation of responses, such as described in the context of FIGS. 4 and 5. The interface (310) includes a first response (312) based on a first response dataset and a second response (313) based on a second response dataset. The interfaces may display a plurality of responses (312, 313) in a list or other format that may be scrolled through, searched, filtered, sorted, and so on. In a multi-response display format, responses may be selected and updated or approved in batches (e.g., each response may be selected or checked, and then a single approval, rejection, or other operation may be applied to all selected responses). In some implementations, responses (312, 313) may be displayed singularly to a curator user and then approved, modified, or rejected singularly. In single response display formats, responses may be selected and displayed to a curator user for review sequentially in the order that they were received, or may be selected by the system and displayed for curation based upon a priority for review associated with the response (e.g., high priority (148) responses may be selected for review over standard priority (136), or responses that are determined to be of high urgency (156) may be selected for review over other low urgency responses).

When displayed via the interface (310), a response such as the first response (312) may be displayed with minimal or essential content and information, and a small set of single click, or minimal click controls and features that may be used to rapidly review the current status and attributes of the response (e.g., after automatic curation and analysis), make any needed modifications, and commit or approve the response record so that subsequent responses may be displayed or reviewed. In the example of FIG. 6B, each response includes a theme summary pane (314) that displays a brief theme or sub-category for the response that is derived from the response content, which may be viewed in a content pane (318). A respondent info pane (316) includes information associated with the respondent profile from which the response was received, and may include varying levels of information based upon respondent privacy settings and preferences (e.g., where a respondent replies with a message or response indicating that they desire anonymity, the respondent info pane (316) may be partially or entirely anonymized).

The theme summary pane (314) and content pane (318) may be selected by a curator and modified, such as where an automatically determined theme attribute or summary in the theme pane (314) is determined by a curator to require editing, or where content in a content pane (318) may be selected and manually edited to remove particular student or parent names, or to correct spelling or other errors that obfuscate the meaning of the response, or to correct spelling or grammar errors introduced during software translation from one language to another, and so on. In some implementations, the theme pane (314) may be selected and manually edited by typing, or may be selected to present a drop-down box or menu with a plurality of pre-configured themes that the curator may choose from (e.g., “Ideas—coffee with teacher” may be automatically determined based on the response content, and a curator user may select a similar theme from a list of pre-configured themes such as “Ideas—teacher meet and greet”).

The interface (310) also includes a set of quick controls (320) that may be operated by a curator user with a single click or minimal number of clicks to quickly update attributes of the response. The quick controls (320) includes a category selector (322) that displays five categories that the response may be assigned to, and a category determined by the system automatically is displayed with a category selection (324) to indicate an attribute currently associated with the response. In some implementations, the quick control (320) logic may be interdependent between controls. As an example, the category selector (322) may be configured to only allow a single category to be selected for the response so that a 1-to-1 relationship between category and response is enforced (e.g., where a curator user selects the “Community and Culture” category, the selection (324) would be removed from “Teacher and Staff” and moved to the newly selected category).

The quick controls (320) also includes a type selector (326) that displays two different types that the response may be associated with, and a type determined by the system automatically is displayed with a type selection (328) to indicate a type attribute currently associated with the response. As with category, the type selector (326) may be configured to allow selection of only a single type (e.g., where the curator selects “Praise”, “Feedback” will be deselected). The quick controls (320) may also be configured to enforce logic around the display and/or usability of buttons or other controls that depend upon the selection of other controls. As an example, in some implementations, the “Follow Up: Question” and “Follow Up: Challenge” buttons may only be selectable for response associated with a “Feedback” type, and so may not be displayed, or may be displayed but not be selectable, when a response is associated with a “Praise” type.

Quick controls (320) may also include selectable buttons for other response attributes, such as a “Trends” button that may be selected when the response shares a trend or characteristic with other contemporaneously received responses (e.g., where multiple respondents voice concerns over cold or flu season, automatic and/or manual curation of responses may begin to flag those responses as part of a trend). As another example, certain response may be assigned different attributes to indicate they are worthy of being highlighted on a school or district level report or other interface, or may be assigned attributes to indicate that they are “Wow” level praise or “Wow” level feedback, and so are worthy of special consideration or attention to recognize praise or address feedback at a school or classroom level.

In some implementations, visual selectors (324, 328) that indicate currently assigned attributes may be presented by the interface (310) in a visually distinct manner depending upon the circumstances of their selection or assignment (e.g., while selectors (324, 328) are shown as dotted-line boxes, it should be understood that they may also be presented as overlays, foreground/background color styles, and other visually distinct designs). For example, suppose that the category selection (324) for the first response (312) was automatically assigned based upon automated analysis by the system. In such a case, the category selection (324) may be displayed in a color, style, or other visually distinct manner that is associated with automatic determination, and when a curator user selects to reassign the attribute to “Community and Culture” the category selection (324) may be displayed in a different visually distinct manner to indicate it was manually assigned (e.g., an automatically assigned category may have a yellow selector box, while a manually assigned or confirmed category may have a green selector box).

As another similar example, where category, or another attribute, is automatically assigned based upon analysis by the system, the selection (324) may be visually distinct based upon the confidence, outcome, or result of the analysis, and so may be displayed in varying colors or other visual styles to indicate the system's confidence in the automatic assignment. For example, where an automatic analysis determines that the proper category is “Teacher and Staff” with a confidence score or rating equivalent to about 80% or higher, the selection (324) box may be green to indicate high confidence. Where automatic analysis determines that category with a confidence score of 60% or less, the selection (324) box may be yellow to indicate relatively low confidence. In each case, once updated or selected by a user, the selection (324) may again change to indicate high confidence manual selection.

In some implementations, the buttons of the category selector (322) may each be displayed with a visual indicator of the confidence of an underlying automatic analysis of the response, to provide further context and info to a manual curator (e.g., the five category buttons may be displayed with a color, style, or other visual distinction that corresponds to the confidence in automatic analysis, or may be displayed with a number indicating confidence, or otherwise). In one example, the five category buttons may each be displayed with a numerical indicator of confidence in the automatic analysis that totals up to near 100% (e.g., “Academic: 5%; Teacher and Staff: 75%; Community and Culture: 15%; Operations: 1%; General: 4%”). In this manner, where a curator has concerns about the viability of the automatically selected category, the confidence information related to the other categories is readily available to help guide their selection of an updated category.

FIG. 6C is a screenshot of an exemplary feedback interface (330) that displays feedback status information for a particular respondent pool during a particular survey, or for one or more respondent pools over a period of time. The interface (330) may be sorted and filtered to only display high urgency feedback for example, and displayed information may include an urgency for each theme, a description for each theme, and a volume indicator that shows the prevalence of the theme's presence in responses.

FIG. 6D is a screenshot of an exemplary feedback action interface (340) that displays feedback action information. Information for the interface (340) may be populated based upon curation of responses, and may include identification of a question or challenge arising from responses associated with a feedback/criticism type. A solution column may be pre-configured by providers of the system or school administrator users to present a suggested solution to each question/challenge, and may be selected and associated with each question/challenge based upon categories, themes, and other attributes determined for the response. Each solution may be presented with a functional button or other control that allows an administrative user to trigger an appropriate action based on the solution, which may include emailing information to the respondent, notifying a teacher or other staff member to take some action, scheduling a meeting between the respondent and staff, or other actions. For example, a send button (342) associated with the “Food Needs” challenge may be clicked to automatically deliver the schools most recent lunch calendar and/or other lunch related information to the respondent, as outlined by the Solution column.

FIG. 6E is a screenshot of an exemplary sentiment interface (350) that displays sentiment status information that is determined based upon respondents quantitative responses to surveys, as well as information on category and type of responses that have been received. A sentiment visualization (352) is based on quantitative responses received from respondents, and indicates respondent sentiment relating to the school's recent performance. A praise category visualization (354) is shown as a pie chart indicating where praise is most likely (e.g., “Teacher and Staff” category most likely to receive praise) and least likely (e.g., “Academics” category least likely to receive praise). A feedback category visualization (356) is shown as a pie chart indicating where feedback/criticism is most likely (e.g., “Social” category most likely to receive criticism) and least likely (e.g., “Teacher and Staff” category least likely to receive criticism).

It should be understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

1. A system configured to conduct surveys related to school performance comprising:
(a) one or more processors;
(b) a data storage configured to store:
(i) one or more respondent pools, wherein each respondent pool describes a population of respondents associated with a school;
(ii) a plurality of respondent profiles, wherein each respondent profile is uniquely associated with one respondent and one respondent pool of the one or more respondent pools;
(c) a communication device that is communicatively coupled to a messaging service;
wherein the one or more processors are configured to:
(i) organize outbound survey questions and inbound survey responses into a plurality of conversation threads using the plurality of respondent profiles, wherein each conversation thread is uniquely associated with one respondent and one respondent pool;
(ii) when conducting a survey for a respondent pool via the messaging service:
(A) provide a first question to the population of respondents for the respondent pool;
(B) receive a first response to the first question from a respondent of the population of respondents, and analyze the first response to determine a first set of response attributes;
(C) determine a second question based on the first set of response attributes, and provide the second question to the respondent; and
(D) receive a second response to the second question from the respondent and analyze the second response to determine a second set of response attributes; and
(iii) cause a curation interface to display on a curator user device of a curator user based on the first response, the second response, the first set of response attributes, and the second set of response attributes.

2. The system of claim 1, wherein the one or more processors are further configured to:
(i) associate an outbound identifier with each respondent pool of the one or more respondent pools, wherein the outbound identifier is inherent in any outbound communication to the population of respondents for that respondent pool; and
(ii) for each respondent pool of the one or more respondent pools, receive a contact dataset that includes an inbound identifier for each respondent of the population of respondents, and create the plurality of respondent profiles for that respondent pool based upon the inbound identifier for each respondent and the outbound identifier for that respondent pool, wherein the inbound identifier is inherent in any inbound communication from that respondent.

3. The system of claim 2, wherein the outbound identifier comprises a first telephone number, the inbound identifier comprises a second telephone number, and the messaging service comprises an electronic text messaging service configured to provide and receive text messages via telephone numbers.

4. The system of claim 2, wherein the respondent is included in the population of respondents for two or more respondent pools, and is associated with two or more conversation threads of the plurality of conversation threads.

5. The system of claim 1, wherein the one or more processors are configured to:
(i) associate the first question with a standard message priority;
(ii) associate the second question with a high message priority; and
(iii) when providing questions to the population of respondents, prioritize transmission of questions to the messaging service to ensure that questions with high message priority are given preference over questions with standard message priority.

6. The system of claim 5, wherein the one or more processors are further configured to:
(i) manage one or more outbound message queues from which messages are selected and provided to the messaging service;
(ii) where there is no message with high message priority in the one or more outbound message queues, select and provide a next standard priority message from the one or more outbound message queues to the messaging service; and
(iii) where there is at least one message with a high message priority in the one or more outbound message queues, select and provide a first high priority message from the one or more outbound message queues to the messaging service.

7. The system of claim 1, wherein:
(i) the first question comprises a prompt to provide the first response as a quantitative response; and
(ii) the one or more processors are further configured to analyze the first response as the quantitative response and determine a response type as one of the first set of response attributes, wherein the response type comprises a quantitative sentiment indicator.

8. The system of claim 7, wherein the one or more processors are further configured to:
(i) where the quantitative sentiment indicator indicates a positive sentiment, determine the second question as a pre-configured follow up question for a positive sentiment respondent; and
(ii) where the quantitative sentiment indicator indicates a negative sentiment, determine the second question as a pre-configured follow up question for a negative sentiment respondent.

9. The system of claim 7, wherein:
(i) the second question comprises a prompt to provide the second response as a qualitative response; and
(ii) the one or more processors are further configured to analyze the second response as the qualitative response and determine a response category and a response theme as part of the second set of response attributes.

10. The system of claim 9, wherein the one or more processors are further configured to, when analyzing the second response as the qualitative response, use one or more of:
(i) a pre-configured keyword analysis configured;
(ii) a natural language processing function; and
(iii) an artificial intelligence function.

11. The system of claim 1, wherein the curation interface is configured to cause the curator user device to display, for at least one respondent of a plurality of respondents from which second responses were received:
(i) at least a portion of the second response from that respondent;
(ii) a category selector comprising three or more category buttons, wherein a category button of the three or more category buttons is pre-selected based upon a response category determined as one of the second set of response attributes, and wherein the category selector is configured to allow the curator user to modify the response category by selecting one of the three or more category buttons;
(iii) a type selector comprising two or more type buttons, wherein a type button of two or more type buttons is pre-selected based upon a response type determined as one of the first set of response attributes, and wherein the type selector is configured to allow the curator user to modify the response type by selecting one of the two or more type buttons; and
(iv) one or more additional attribute buttons configured to allow the curator user to modify a corresponding attribute by selecting one of the one or more additional attribute buttons.

12. The system of claim 11, wherein the curation interface is configured to:
(i) determine the one or more additional attribute buttons that are selectable by the curator user based on whether the response type indicates positive sentiment or negative sentiment;
(ii) prevent multiple simultaneous selection of more than one of the three or more category buttons; and
(iii) prevent multiple simultaneous selection of more than one of the two or more type buttons.

13. The system of claim 1, wherein the data storage is further configured to store a plurality of analytical functions that are configured to determine the first set of response attributes and the second set of response attributes, and wherein the one or more processors are further configured to:
(i) receive an attribute update via the curation interface that describes a corrected value set for an attribute of the first set of response attributes or the second set of response attributes, wherein the manual value overrides an automatic value provided by an analytical function of the plurality of analytical functions;
(ii) modify the attribute to reflect that the corrected value overrides the automatic value; and
(iii) update the analytical function based on the corrected value and at least a portion of response content, such that when presented with the same or similar input the updated analytical function will be more likely to output the corrected value as the automatic value.

14. The system of claim 1, wherein the one or more processors are further configured to cause a report interface to display on a user device of a user, wherein the report interface is configured to cause the user device to selectively display:
(i) a respondent status interface that describes response activity for a population of respondents for one or more respondent pools;
(ii) a feedback interface that describes urgency and volume for a plurality of themes identified in responses as part of the second set of response attributes;
(iii) a sentiment interface that describes a quantitative sentiment value determined as part of the first set of response attributes, a description of response categories most likely to be associated with a positive response type, and a description of response categories most likely to be associate with a negative response type; and
(iv) a feedback action interface that describes a pre-configured action to address the second response received from a particular respondent, wherein the feedback action interface includes a control element that is configured to be interacted with by the user to automatically execute the pre-configured action.

15. A method for conducting surveys related to school performance comprising, by one or more processors:
(a) configuring a data storage to store:
(i) one or more respondent pools, wherein each respondent pool describes a population of respondents associated with a school; and
(ii) a plurality of respondent profiles, wherein each respondent profile is uniquely associated with one respondent and one respondent pool of the one or more respondent pools;
(b) organizing outbound survey questions and inbound survey responses into a plurality of conversation threads using the plurality of respondent profiles, wherein each conversation thread is uniquely associated with one respondent and one respondent pool;
(c) conducting a survey for a respondent pool via a messaging service by:
(i) providing a first question to the population of respondents for the respondent pool;
(ii) receiving a first response to the first question from a respondent of the population of respondents, and analyzing the first response to determine a first set of response attributes;
(iii) determining a second question based on the first set of response attributes, and providing the second question to the respondent; and
(iv) receiving a second response to the second question from the respondent and analyzing the second response to determine a second set of response attributes; and
(d) causing a curation interface to display on a curator user device of a curator user based on the first response, the second response, the first set of response attributes, and the second set of response attributes.

16. The method of claim 15, further comprising:
(i) associating an outbound identifier with each respondent pool of the one or more respondent pools, wherein the outbound identifier is inherent in any outbound communication to the population of respondents for that respondent pool; and
(ii) for each respondent pool of the one or more respondent pools, receiving a contact dataset that includes an inbound identifier for each respondent of the population of respondents, and creating the plurality of respondent profiles for that respondent pool based upon the inbound identifier for each respondent and the outbound identifier for that respondent pool, wherein the inbound identifier is inherent in any inbound communication from that respondent.

17. The method of claim 15, further comprising:
(i) associating the first question with a standard message priority;
(ii) associating the second question with a high message priority; and
(iii) when providing questions to the population of respondents, prioritizing transmission of questions to the messaging service to ensure that questions with high message priority are given preference over questions with standard message priority.

18. The method of claim 15, wherein the first question comprises a prompt to provide the first response as a quantitative response, the method further comprising:
(i) analyzing the first response as the quantitative response and determining a response type as one of the first set of response attributes, wherein the response type comprises a quantitative sentiment indicator.
(ii) where the quantitative sentiment indicator indicates a positive sentiment, determining the second question as a pre-configured follow up question for a positive sentiment respondent; and
(iii) where the quantitative sentiment indicator indicates a negative sentiment, determining the second question as a pre-configured follow up question for a negative sentiment respondent.

19. The method of claim 17, wherein the second question comprises a prompt to provide the second response as a qualitative response, the method further comprising analyzing the second response as the qualitative response and determining a response category and a response theme as part of the second set of response attributes.

20. A system configured to conduct surveys related to school performance comprising:
(a) one or more processors; and
(b) a data storage configured to store:
(i) one or more respondent pools, wherein each respondent pool describes a population of respondents associated with a school;
(ii) a plurality of respondent profiles, wherein each respondent profile is uniquely associated with one respondent and one respondent pool of the one or more respondent pools;
wherein the one or more processors are configured to:
(i) organize outbound survey questions and inbound survey responses into a plurality of conversation threads using the plurality of respondent profiles, wherein each conversation thread is uniquely associated with one respondent and one respondent pool;
(ii) when conducting a survey for a respondent pool of the one or more respondent pools, receive a plurality of responses from the population of respondents and analyze the plurality of responses to determine a set of response attributes;
(iii) cause a curation interface to display on a curator user device of a curator user, wherein the curation interface is configured to cause the curator user device to display, for at least one respondent of the population of respondents from which a response of the plurality of responses was received:
(A) at least a portion of the response from that respondent;
(B) a category selector comprising three or more category buttons, wherein a category button of the three or more category buttons is pre-selected based upon a response category determined as one of the set of response attributes, and wherein the category selector is configured to allow the curator user to modify the response category by selecting one of the three or more category buttons; and
(C) a type selector comprising two or more type buttons, wherein a type button of two or more type buttons is pre-selected based upon a response type determined as one of the set of response attributes, and wherein the type selector is configured to allow the curator user to modify the response type by selecting one of the two or more type buttons.
